(19) United States
(12) Patent Application Publication
(10) Pub. No.: US 2012/0215712 A1
(43) Pub. Date: Aug. 23, 2012

(54) System and database for education

(76) Inventor: Tariq Malki, Dammam (SA)

(21) Appl. No.: 13/400,025

(22) Filed: Feb. 17, 2012

Related U.S. Application Data
(60) Provisional application No. 61/463,475, filed on Feb. 17, 2011.

(51) Int. Cl. G06Q 50/20

(52) U.S. Cl. 705/327

(57) ABSTRACT

A method, a system, a computer program product, and a database organization for a multi-language membership website for use by individuals—both members and visitors—, companies, providers, and experts. The product supplies information about education opportunities with a primary intention of directing users to educators. Users can select an occupational goal and the product will direct the users to education providers so the user may advance professionally.

This invention claims priority to Provisional Application 61/463,475.

### FIELD OF THE INVENTION

This invention pertains to multinational, multi-language systems and databases of education opportunities.

### BACKGROUND OF THE INVENTION

The present invention relates to the field of education and professional advancement of individuals and, in particular, to online systems and methods of directing individuals to providers of such education. The invention consists of a database of providers plus a system of computer programs which direct users to these providers. In addition, the system permits visitors as well as members to query the database. It also permits providers to add to the database. Further, it permits experts to assist users in using the database and the education opportunities described therein.

As the world becomes more and more technologically oriented, there exists an ever-growing need for individuals to obtain education and training in their fields. Individuals who want to do more than just stay level with technology will be left behind so they must obtain additional education and training throughout their lives. Companies benefit from having well-educated employees. When companies downsize, the best-educated employees, the ones with the education and training to fill the new slots are the ones most likely to be retained.

To educate, there must be providers of education and training. Providers must find ways to have the users, who need the education and training, locate the providers and, in essence, buy their services.

Specialized experts an areas of education and training have services to sell. They, too, must find ways to have the users locate these experts when the users need special assistance in learning a subject.

At present, individuals have no simple, single source of the information they need to show them where they can find the education and training. Further, individuals may not speak English. For these individuals, there is a need for education and training in a language they understand. There is also a need for education and training that will fit into the individual's life and schedule. Not everyone can take off the time to attend a school or college on site and full time. People already employed must study by correspondence courses or online or part-time. Another level of challenge arises for would-be students in countries other than the United States. For many students, there has been no place to direct them to satisfactory education and training.

The invention is an international, multi-language membership website and business networking destination that solves the above-mentioned problems by combining a database of education and train opportunities with a system which locates these opportunities.

### SUMMARY OF THE INVENTION

The invention consists of a plurality of inter-related components which combine into a system to solve the stated problems. The system, known as Lbeeb, may be better understood from a description of how individuals, companies, providers, and experts use the system. The system links users via the internet or network to its website using methods well-known in the art.

All users enter the system at a common entry point, the system home page. At the system home page, the user chooses whether to follow the visitor path or the member path. Note that in some places these entry points and paths may be called “terminals”. This term does refer to work stations but to their being one end of the path, thus, a terminal. Visitors also have the option on this system home page of registering to become members. Visitors may, without registering, view the data by entering a subject or education goal in the box and having the system search for providers of education or training in that subject or leading to that goal. The system then locates records with descriptions of providers of this education or training. The records are presented to the visitor in abbreviated form including the Topic, Certificate or Degree Type, the Location, a description of the course, the name of the provider, and up to five stars to show how those who have used the course evaluate the course.

At the display of these records, visitors who speak languages other than English may select a different language, including Arabic, French, Spanish, German, Russian, Portuguese, Hindi, Chinese, Japanese, and Italian. If the visitor selects a different language, the system will present a new set of records for courses in the selected language. Users may come from anywhere in the world that there is access to the internet.

By selecting the Topic by clicking on it the topic name displayed, the visitor next sees a list of the available course descriptions that make up the program leading to the certificate or degree. This is followed by more detailed descriptions of the courses themselves. In addition, the visitor is shown the type of presentation of the course, that is, whether the course is video, online, distance, correspondence, seminar, regular, short, long or some other type. There is a space where the visitor can enter a request for further information from the provider. Where there are available experts to provide assistance to a user, there are links to such experts.

A visitor may decide to register and become a member. In that case, the visitor goes to the Member Registration section of the system home page and completes the requested information which includes name, email address and password. Having registered as a Member, the system than asks for more information including Personal Details (Name, Industry, Job Title, Country, City, Address, Email, Telephone, Mobile Phone, and such) along with Educational Details (Program Name, Provider, Year, Duration, Certification Type, and such), Experience Details (Job Title, From and To Dates, Company Name, Country, City, and such), current Job Details (Job Title/Industry Type), and Target Job (Job Title/Industry Type). This is the sort of information that would be contained in a resume or job history. It assists the system in narrowing the search for the best courses for the new Member. This data is then entered in the Member's Database. Members can register for courses via the system.

A visitor can sign up as a Corporate Member. A Corporate Member is one who has employees who will using the system as individual Members. The term “employee” is to be given its broadest sense including employees, contractors, sub-contractors, volunteers, interns, students, and anyone providing labor or service to a business entity. As used here, the term “Corporate” or “Corporation” refer to any type of business organization including proprietorships, partnerships, joint ventures, corporations, farms, military units, and government entities. The term “Corporate” or “Corporation” is to be read in its broadest sense. In essence, Corporate Members register multiple users. Corporate members may manage accounts of many individual members.

Providers may select the Providers Login from the system home page. A provider supplies details about that Provider (Language, Country, City, Address, Name, Contact Person Name, Email, Telephone, Mobile Phone, Website, About Us Page, Large Logo, Small Logo, Preferred Currency, Industry, and such), provider's List of Programs/Services, provider's Promotion/Payment Details, provider's Program Details for every program (Code, Category/Field, Program Type, Certificate or Degree Type, Industry, Job Title, Attendance Type, Languages, Keywords, URL, Contact Person, Contact Mail, and such), details for Occurrence/Event of each program (Country, City, Start Date, End Date, Start Time, End Time, Venue, Price, and such) and overall Price. This data is entered into the Provider Database. Providers may also download standard Excel spreadsheets with this data.

A member may upgrade the account to be an Expert or Trainer, Would-be Experts and Trainer must provide qualification and experience details. Trainers and experts provide services to other members. The details of the trainer and expert qualifications are made available to other members and providers.

Providers may log in to the Provider Homepage. There, providers may obtain important statistics, messages, and alerts. Providers may update their entries in the Provider Database. Providers can elect to add one program, one event, many programs, or many events. An “event” tells how, where, and when a “program” is conducted. A “program” is a series of one or more events. The system selects different paths depending on which path the Provider has elected. A Provider can even upload a table of information to the system for inclusion in the Provider Database. There is even a frame or outline table to make such uploads easier. The Provider may indicate the type of program or document, including video, flash, pdf, or other document format. The system allows a Provider to review the new data and to edit the new data before it is passed to the Provider Database.

Providers may create a Favorites List which will contain links to other providers, programs, trainers, experts, or members. A provider may add notes links which can be linked to that provider's programs and can be accessed. Another feature permits providers to see which of that provider's programs have had member notes attached without seeing the notes themselves. A provider is notified when a member registers for a particular program.

Providers and Members may communicate with one another through the system using an “inbox”.

Members may mark a provider's program as “wrong classification”. If this occurs, the provider is sent an alert that there may be something wrong in the program details. Providers can see all such alerts and act to correct the problems, if any.

Providers pay to be listed in the database. Providers may purchase units (credits). Providers may be shown the details of consumed and remaining units. Providers may be shown information on plans for purchasing new units.

Providers may add a promotional line under all their programs. Providers may edit or delete a promotional line if desired.

Once a member has registered, each time the Member logs in, the Member is taken to the Member Homepage where the Member is shown important statistics, alerts, and messages. The Member is also given a list of options which include links to recommended programs, industries, training fields, favorites, and notes. The system gives the member the list of programs that relate as well as a list of programs last visited. As noted earlier, a member may request registration to a program and may obtain the provider details, communicate with the provider, add the provider to the favorites list, hide that member's programs so they will not appear in search results, and hide experts and trainers so they do not appear either.

A member may create a development plan by adding programs to the member's calendar. This addition can be done by subject matter expert. This way, the member may request related services from providers or trainers and experts.

Members may also communicate with other members by using the “inbox” feature where messages are managed. Members may view, reply, archive, or delete messages.

Members may change their details. This may allow a member to find other providers, programs, trainers, experts, and even groups of these. Groups can be formed by members who share similar details, such as, job title, industry type, and interest. These groups are sometimes called “people like me”.

If providers upload online learning materials, members are able to learn online. It is up to the provider whether to charge for such services or to provide them free of charge.

The system allows member to dialogue with others by adding questions and answering them in a forum. Members may share their evaluation of programs, providers, trainers, and experts.

All users have several other useful tools. One is the “advanced search” which permits a user to add conditions or criteria to a search, thus narrowing the number of hits resulting from the search. Users may search then refine their search repeatedly should they so choose. All users as well as external parties may advertize on the system to market products and services to users. The system does this by placing ads in certain locations and can send emails to users who opt in to receiving emails.

The database consists of multiple inter-related databases using a multi-level architecture where, for the Industry Types and Job Types, there are three levels and for Training and Education Programs and their Providers and Details, there are four levels. As the database grows, additional levels may be added to accommodate additional groupings.

### BRIEF DESCRIPTION OF THE DRAWINGS

The invention will be better understood from a reading of the following detailed description taken in conjunction with the drawing figures, in which like reference designators are used to identify like elements, in which:

FIG. 1 diagrams the System Home Page interfacing via the Internet or Network with the Website.

FIG. 2 shows the three level Industry Types database.

FIG. 3 shows the three level Job Titles database.

FIG. 4 shows the four level Training and Education Programs and Their Providers and Details database.

FIG. 5 shows that the three databases inter-relate.

FIG. 6 shows the flow of control of the system from the point where a Member enters details to where the Provide receives notification.

FIG. 7 shows the flow of control of the system from the point where the Member specifies Requested Program Details to the where the Member and Provider communicate.

FIG. 8 shows the flow of control of the system from the point where the Member specifies the target job title to where Programs are added to the Member's development plan.

FIG. 9 shows the flow of control of the system from the point where a Provider specifies program/service details to where a Provider and trainer/expert communicate.

FIG. 10 shows the flow of control of the system from the point where a Trainer/Expert post details to the point where Provider/Member and Trainer/Expert communicate.

FIG. 11 shows the flow of control of the system around a user browsing the databases.

FIG. 12 shows the flow of control of the system from where a Provider downloads a standard Excel spreadsheet with provider details to where Programs/Events are posted to the website.

FIG. 13 shows the flow of control of the system from where a Provider posts its programs to where the Registration/feedback is sent to the provider's account at Lbeeb.

### DETAILED DESCRIPTION

The system and databases are a novel method for providing information to individuals and corporations where the individuals or corporations wish to improve the skills or knowledge of employees in order that the employees may better serve the interests of the corporations. It is conceded, generally, that better-educated employees better serve their employers. It is anticipated that as the database described herein grows, more and more individuals and corporations will avail themselves of the information thereon. Providers will add to the databases as will trainer and experts.

Heretofore, individuals seeking to educate themselves and corporations seeking to educate employees had to use disconnected searches. Providers had to supply information on web sites. Trainers and experts had to supply information on additional web sites. The preeminent value of this system is that all this information is available in one site. The information is easily accessible. Searches can be tailored to individuals and corporations. Providers can increase their coverage. Those who speak languages other than English can find sources of information readily.

The following paragraphs describe the preferred embodiment of the databases and system

Users who log onto the web site choose from a number of paths. Visitors can select the visitor path by entering an education goal or topic in the Search box. Visitors can become Members by registering at the Registration path. Members log in and use the Member path. Providers can take the Provider path. Trainers and experts can take their path.

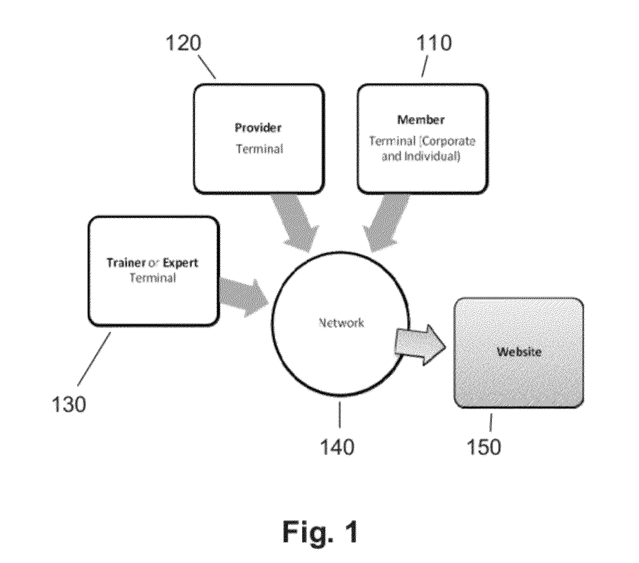

Turning to the Figures, FIG. 1. is an overview of the System Home Page and the interconnections with the internet/network and website. At 110 is the terminal or entry point for a Member, whether Corporate or Individual. At 120 is the terminal or entry point for a Provider. At 130 is the terminal or entry point for a Trainer or Expert. All three, 110, 120, and 130, lead to the network or internet 140. From there, the network 140 passes data to the website 150 for processing.

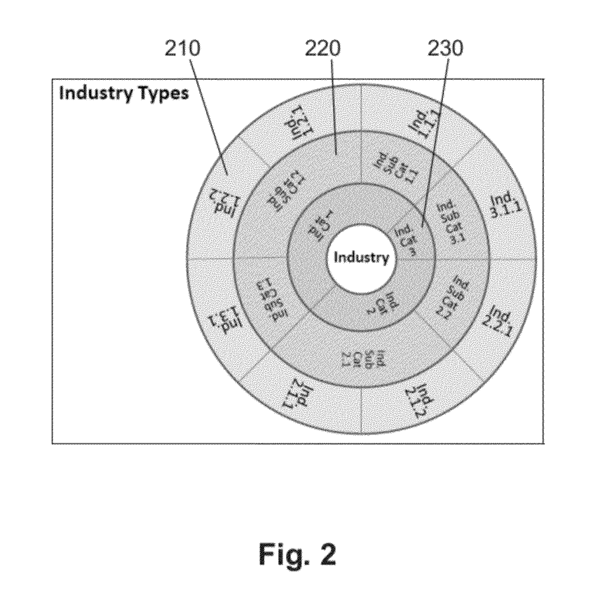

As discussed earlier, one of the databases contains Industry Types, shown in FIG. 2. This database contains three layers, Industries 210, Industry Sub Categories 220, and Industry Categories 230, one within the other in a hierarchical arrangement although there may be cross links between data since some Sub Categories do not fit into just one Industries and some Industry Categories do not fit into just one Sub Category.

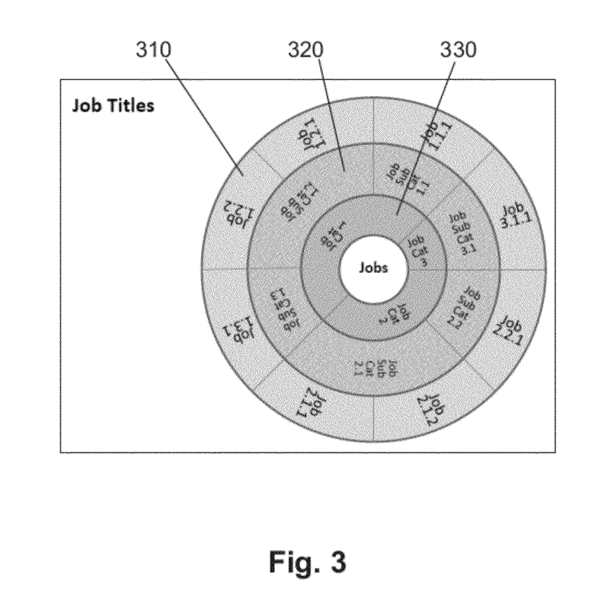

In a similar fashion to FIG. 2, FIG. 3 shows this database has three levels of Job Titles. Jobs 310, Job Sub Categories 320, and Job Categories 330 are within one another in a hierarchical arrangement although there may be cross links because some Job Sub Categories do not fit into just one Job and some Job Categories do not fit into just one Job Sub Category.

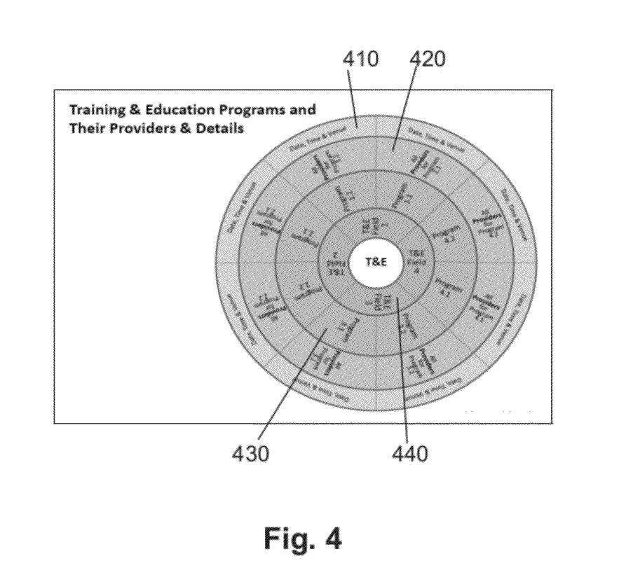

FIG. 4 shows the four levels of Training and Education Programs and Their Providers and Details. This database shows the Date, Time, and Venue 410, All Providers for Program 420, Program 430, and Trainer and Expert Field 440 layers. As before, this database has a hierarchical arrangement but some cross links exist because some Providers for Programs may have multiple Dates, Times, and Venue, some Programs might be linked to more than one Provider, and Trainers and Experts might have training ability and expertise for more than one program, more than one provider, and more than one Date, Time, and Venue.

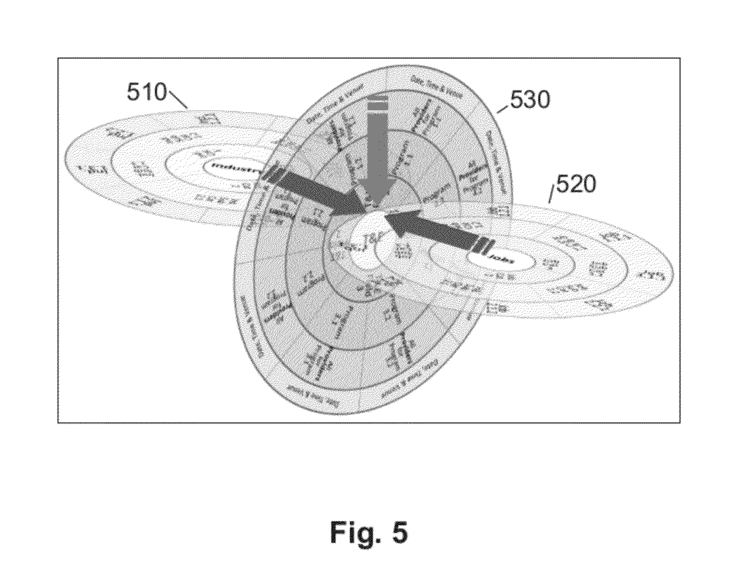

The steps in FIGS. 5 through 12 and the flow of control are not necessarily linear from one figure to another. The steps can be performed independently depending on the needs and desires of the user.

FIG. 5 shows the inter-relationship among the Industry database 510 (FIG. 2), Jobs database 520 (FIG. 3), and Training and Education Programs and Their Providers and Details database 530 (FIG. 4). Each database can link to the others if so directed.

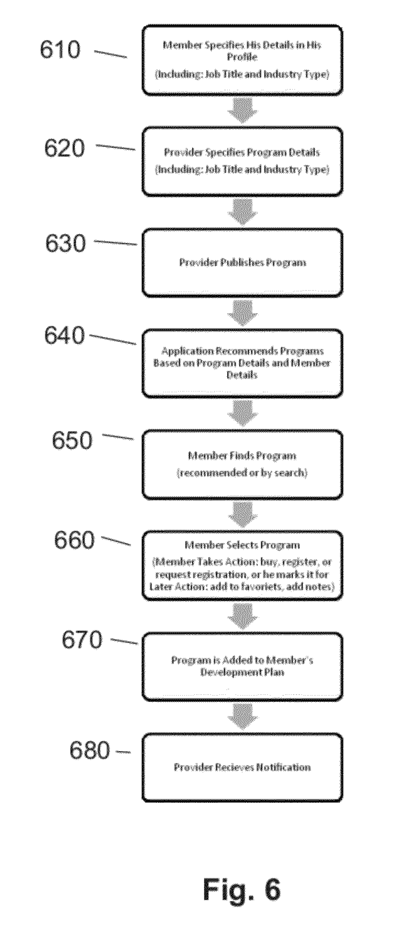

FIG. 6 shows the flow of control beginning with the point where the Member specifies the details in the Member's profile, including Job Title and Industry Type 610. In the next step Provider specifies program details including Job Title and Industry Type 620. In the next step the Provider publishes his program 630. The system application recommends programs to members based on program details and member details 640. Then the Member finds the program recommended or by search 650. Next, the Member selects the program. That is, the Member takes action to buy, register, or request registration or Member marks the program for later action. Member may add the program to Favorites and may add notes. 660. Then the Program is added to the Member's development plan 670. Then the Provider receives notification 680.

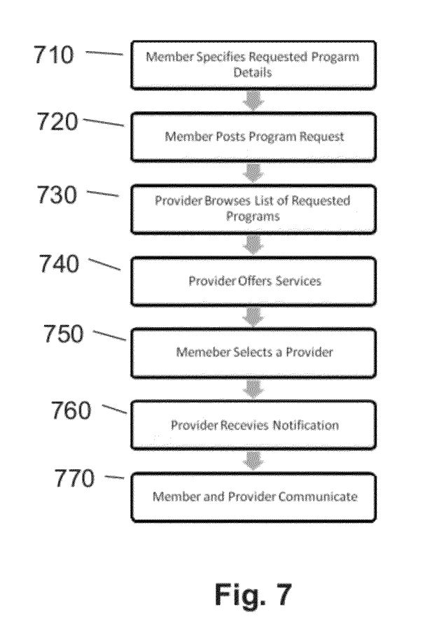

At FIG. 7, the Member specifies requested program details. In the first step, the Member specifies requested program details 710. Next, the Member posts program request 720. Next Provider browses the list of requested programs 730. Then the Provider offers services 740. Next the Member selects a Provider 750. Then the Provider receives notification 760. The Member and Provider communicate 770.

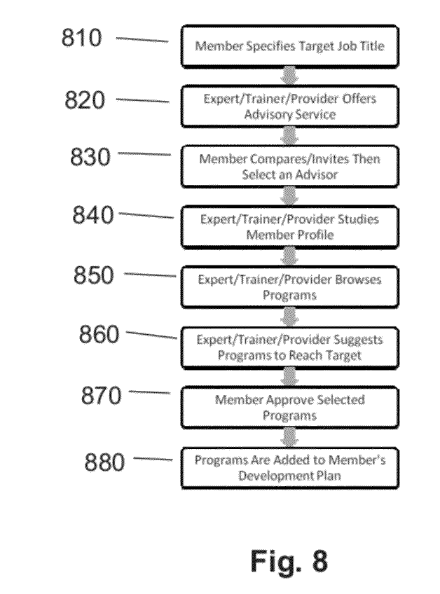

At FIG. 8, Member selects target job title 810. An Expert/Trainer/Provider offers advisory service 820. The Member compares and invites advisors to supply more information then the Member selects and advisor 830. Next, the Expert/Trainer/Provider studies the Member profile 840 then browses the Programs 850 then suggests programs to reach the user's target 860. Member then may approve selected programs 870 and the Programs are added to Member's development plan 880.

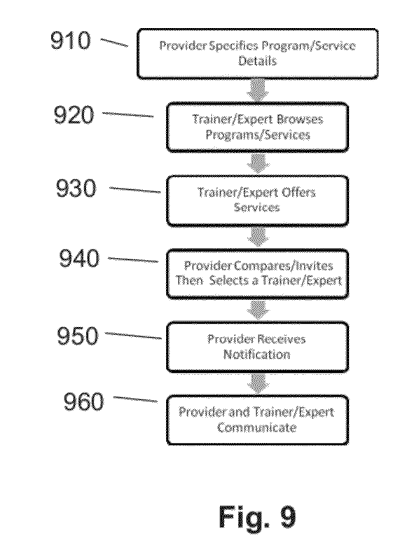

At FIG. 9, Provider specifies program/service details 910. Then Trainer/Expert browses Programs/Services 920, Trainer/Expert next offers services 930. Provider then compares or invites trainers/experts to provide information then selects a trainer/expert 940. Provider then receives notification 950. Lastly, Provider and trainer/expert communicate 960.

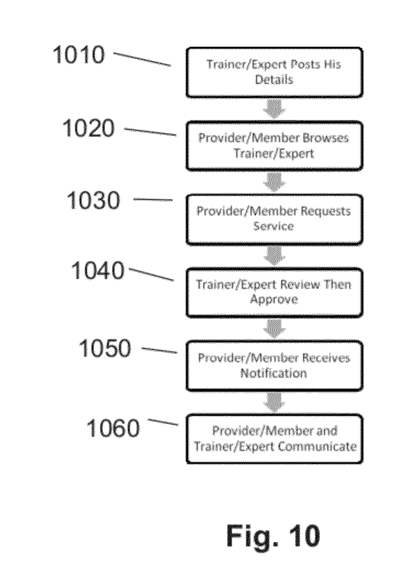

At FIG. 10, Trainer/Expert posts trainer/expert's details 1010. Next Provider or Member browses trainer/expert information 1020. Provider or Member requests service next 1030. Then Trainer/Expert reviews then approves the plan 1040. Next, Provider or Member receives notification 1050. Lastly, Provider or Member and Trainer/Expert communicate 1060.

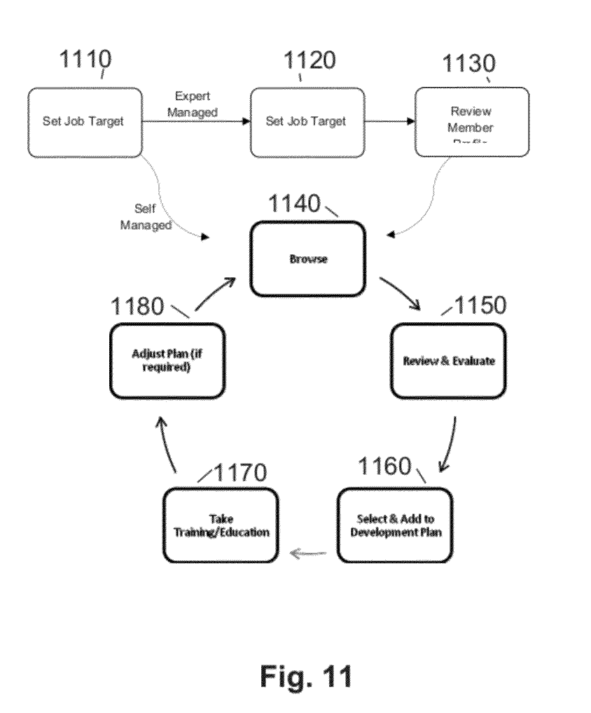

At FIG. 11 is a diagram of how an individual works its way through the system. The individual sets a job target 1110. The individual may have an expert manage the setting of this job target 1120 or may self-manage. If the expert sets the job target 1120, the expert reviews the member profile 1130. Whether self-managed or using an expert, in the next step, the individual, or with help of an expert, browses the program data 1140. Then, the individual, or with help of an expert, reviews and evaluates that program 1150. Next, the individual, or with help of an expert, selects and adds a development plan 1160. Next, the individual takes the training or education. 1170. The individual may have an expert assist but, ultimately, the individual must do the learning. Next, either individually or with an expert, the plan is adjusted if required 1180 the browse step is repeated 1140 until the individual has completed the program.

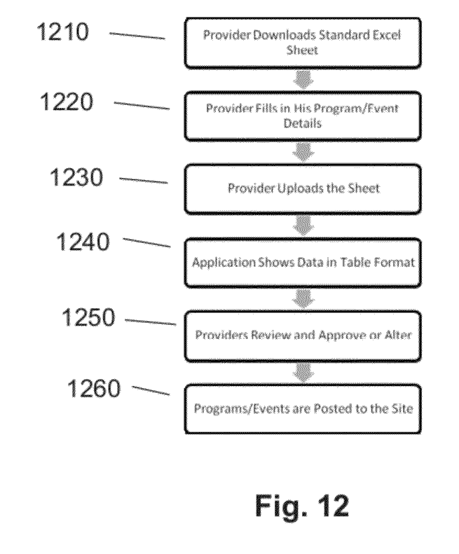

At FIG. 12, Provider downloads a standard Excel spreadsheet 1210. Next, the Provider fills in the Program/Event details 1220. Next, Provider uploads the sheet to the system 1230. The application shows data in table format 1240. Then Providers review and approve or alter 1250. Lastly, the Programs or Events are posted to the website 1260.

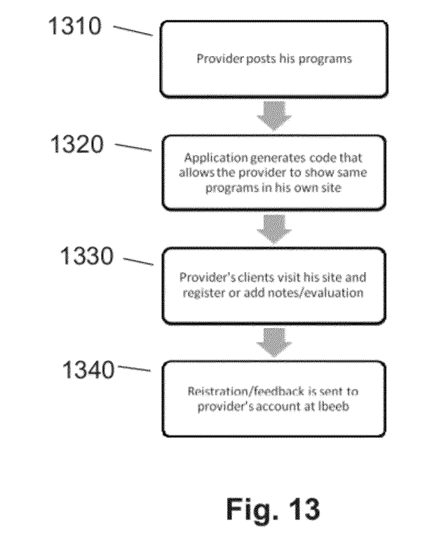

At FIG. 13, Provider posts the programs 1310. The application then generates code that allows the provider to show the same programs at its own site 1320. Then, the Provider's clients visit the site and register or add notes and evaluations 1340. Registration and feedback is sent to provider's account on the Lbeeb system.

A preferred embodiment of the present invention has been described. Nevertheless, it will be understood that various modifications may be made without departing from the spirit and scope of the invention. Accordingly, other embodiments are within the scope of the following claims.

In this description, references to “one embodiment” or “an embodiment: mean that the feature being referred to is included in at least the art. Thus, the invention may include any variety of combinations and/or integrations of the embodiments described herein.

1. I claim an international, multilanguage membership system comprising a system and a plurality of databases wherein said system and databases direct users to sources of education and training opportunities.

2. The system of claim 1 wherein users may come from anywhere in the world that there is access to the internet.

3. The system of claim 1 wherein said education and training may be obtained in Arabic, English, French, Spanish, German, Russian, Portuguese, Hindi, Chinese, Japanese, and Italian.

4. The system of claim 1 wherein said users may be visitors, members, providers, experts, and trainers.

5. The system of claim 1 wherein said databases include databases of industries, jobs, provider programs, experts, and trainers.

6. The system of claim 1 wherein users may be visitors, members, providers, experts, and trainers.

7. The system of claim 1 wherein users enter at the system home page.

8. The system of claim 7 wherein users at the system home page choose whether to follow the visitor path or member path.

9. The system of claim 8 wherein users who may register as members by providing the system with their name, industry, job title, country, city, address, email, telephone, mobile phone, program name and provider, year, duration, certification type, industry type, and target job with job title and industry type.

10. The system of claim 9 wherein said system enters the data from said user in the member's database.

11. The system of claim 1 wherein users may register as corporate members.

12. The system of claim 11 wherein corporate members my register multiple employees as users.

13. The system of claim 6 wherein providers may register and provide language, country, city, address, name, contact person name, email, telephone, mobile phone, website, about us page, large logo, small logo, preferred currency, and industry.

14. The system of claim 13 wherein providers provide a list of programs and services provided by that provider along with any promotional and payment details, program details for all programs including code, category or field, program type, certificate or degree type, industry, job title, attendance type, languages, keywords, URL, contact person, and contact mail.

15. The system of claim 14 wherein for each program the provider provides for each occurrence the country, city, start date, end date, start time, end time, venue, and price.

16. The system of claim 15 wherein all data provided by providers is entered into the provider database.

17. The system of claim 6 wherein experts and trainers may register and provide qualification and experience details, said details being made available to other members and providers.

18. The system of claim 17 wherein experts and trainers provide services to other members.

19. The system of claim 16 wherein providers may log in and obtain important statistics, messages, and alerts, may update their database entries either one at a time or in multiples, may upload tables of information to the system for inclusion in the provider database, may use frames or outline tables for said uploading, and may create lists of favorites which contain links to other providers, programs, trainers, experts, and members.

20. The system of claim 6 wherein providers and members may communicate with one another using an inbox and may communicate via forums.

21. The system of claim 16 wherein members may mark a provider's program as being in a wrong classification.

22. The system of claim 6 wherein providers pay to be listed in the database, may include promotional lines in their entries, and may advertize.

23. The system of claim 10 wherein members log in and review lists of programs that will assist the members in achieving job goals.

24. The system of claim 1 wherein said databases are inter-related and link to one another using a multi-level architecture.
